(19) United States
(12) Patent Application Publication
(10) Pub. No.: US 2010/0070347 A1
(43) Pub. Date: Mar. 18, 2010

(54) Using Conflict of Interest [COI] Method and System in Creating Investment Portfolio

(76) Inventor: William Chen, Rowland Heights, CA (US)

Correspondence Address: William Chen, 28130 Peacock Ridge Drive, #310, Rancho Palos Verdes, CA, 90275, US

(21) Appl. No.: 12/172,240

(22) Filed: Jul. 13, 2008

(51) Int. Cl. G06Q 40/00; G06Q 90/00; G06Q 10/00; G06F 17/30

(52) U.S. Cl. 705/11; 705/500; 705/36 R; 707/802; 707/769; 707/705; 707/E17.044; 707/E17.014

(57) ABSTRACT

In the past, the practice of creating investment portfolio has been focused on the diversification of investment without specifically identifying investment risks. This invention is related to a method of diversification which considers the level of potential for conflict of interest (COI) risk as part of a diversification process. The COI has its origin in the interaction among market participants, market structure, business arrangement and practice. The advantage of the present invention is that the COI becomes a primary factor in creating the portfolio. This method provides a direct analysis of the COI risk that associates with entire investment process and the manager, and it is further integrated into the portfolio creation process. The COI Method opens new paths to perform risk analysis and could be integrated into decision process in other fields of investment.

### CROSS-REFERENCE TO RELATED APPLICATIONS

Application Ser. No. 12/111,964

### BACKGROUND OF THE INVENTION

There exists systemic risk in securities markets as evidenced by simultaneous declines in the prices of a large number of securities in one or more markets in a single country or across countries. From past experience, a major decline in opening price reflects the impact of a systemic risk. The specialist on the exchange plays a key role in determining the opening price.

From academic research, the risk is the standard deviation of return; if we focus the study of risk based on a number, the study of risk shifts away from the analysis of real cause of the risk and becomes an exercise of statistical analysis. When we take for granted that systemic risk is part of the investment experience, nothing much can be done, except market regulation, than, the motivation to focus on the study of the real cause of the risk is discouraged.

Asset allocation and diversification have been used as major tools in the field of investment. For investor, two main considerations of asset allocation are time horizon and risk tolerance. The justification for asset allocation is the notion that different asset classes offer non-correlated returns, hence portfolio diversification reduces the overall financial risk in terms of the variability of returns for a given level of expected return.

Diversification is a risk management technique that mixes a wide variety of investments within a portfolio. The rationale behind this technique is that a portfolio of different kinds of investments will, on average, yield higher returns and pose a lower risk than any individual investment found within the portfolio.

The statistical analysis plays a fundamental role in risk assessment, asset allocation and diversification; the multiple dimensions of the risks of investing is reduced into a basic term in statistical analysis: standard deviation, Just image in the old days when an explorer entered the forest to travel to the west, as he faced one large bear, he yelled . . . “What a terrible number!”; A basic risk definition is a gross understatement of the real world risk. We need to go beyond the number, and analyze the real cause of the risk in order to make the risk management program meaningful.

The financial system works because it is built on the foundation of trust. From past experiences, major financial crises have had as their roots a loss of confidence in the system. The causes for loss of confidence are many, but one of importance is the conflict of interests built into the system.

The disadvantage of existing risk assessment, diversification and asset allocation method is that the evaluation of risks associated with investments is a statistical exercise. When focusing on a variety of historical data and forecasting of future expectations, it neglects the direct, physical assessment of real cause of the risk. To illustrate, the Conflict of Interest [COI] risk associated with the entire investment process, including the market participants, business arrangement and operational environment, market structure and many other relevant factors, have been excluded in the past. These neglected factors are essential to consider because they have a direct impact on the risk and performance of the investment.

### BRIEF SUMMARY OF THE INVENTION

The objective of this invention is to introduce COI method as a fact based risk analysis and prevention tool, in complement with the traditional risk assessment approach. The new approach identifies potential for conflict of interest at the early stage of portfolio generation. It shifts the focus to prevention and monitoring.

To introduce COI into the process of diversification of portfolio by analyzing the COI risk associate with the investment process and its component; this method raises the visibility of the conflict of interest within the investment process which is important to be considered by the investor and portfolio manager.

In general, in one aspect, the invention features a method for diversification based on the level of potential for conflict of interest (COI) that associates the investment process and its components. The COI has its origin in the interactions among market participants, business arrangement and practice, operational environment, market structure and other relevant factors.

At the core of the COI method, it consists of Conflict of Interest Score (COIS). The COIS is determined by a qualitative assessment of potential level of conflict of interest for the relevant factors associate with the components of investment process. The components include client (investor), research, investment manager, trader, broker-dealer, dark pool, exchange and regulatory agency. The relevant factors include the background of the client, interaction among market participants, business arrangements and practices, operational environment, market structure, rules, regulations and all other related considerations. The result of the qualitative assessment is expressed in term of low, medium or high potential of conflict of interest, which is assigned a numerical value of 1, 2 or 3, respectively. The numerical value is the COIS for the relevant factor under analysis. The COIS is cumulative. The COIS is compiled into a COIS Assignment Matrix (COISAM).

The COIS Assignment Matrix comprises two parts. The first part, column 1, includes the relevant factors associate with the components of the investment process. The second part, column 2, is the COIS corresponding to the relevant factor in column 1.

Collecting inputs according to Input Check List (ICL) which comprises the COISAM and Manager Related Data (MRD) Selecting the appropriate situations as described in the Column 1 of the COIS Assignment Matrix, corresponding COIS are selected from the column 2. Summation over the selected COIS produces an Overall COIS for the investment process implemented by the manager. This step is repeated for each portfolio manager who will perform an asset allocation task.

Use the Overall COIS and MRD from each manager to populate the ICL Database.

The COI method provides a new framework for analyzing investment related issues. One of the applications is asset allocation by way of diversification of COI risk.

In general, in another aspect, the invention features a system for asset allocation and diversification of COI. It includes a user interface to create the database and to enter a database query to retrieve the output of the process; a memory medium to store the database created by combing the Overall COIS with manager related data; and a processor to process the end user inquiry based on asset allocation policy and requirements.

The advantage of the present invention is that all the relevant factors that are essential but neglected in the past become the focus points in the COI method. This method provides a balanced analysis and evaluation of the entire investment process and its components. It raises the important issue that the conflict of interest has to be considered for the creation of portfolio. The COI method has great flexibility to include as many factors, variables and details as needed for a dynamic environment.

The details of one or more embodiments of the invention are set forth in the description below. Other applications, features, objects, and advantages of the invention will be apparent from the description and from the claims.

### BRIEF DESCRIPTION OF THE SEVERAL VIEWS OF THE DRAWING

Not Applicable

### DETAILED DESCRIPTION OF THE INVENTION

In the past, the practice of creating portfolio has been focused on the diversification base on variety of factors, but the direct and detail analysis of the risk associated with the conflicts of interest inherent within the entire investment process, including the market participants, business arrangement and practice, operational environment, market structure and many other relevant factors have been excluded. These neglected factors are essential to consider because they have direct impact on the performance of portfolio. Focusing on the traditional factors without considering the COI risk associated with the entire investment process and its components is not a balanced method.

This invention is related to the use of COI method to complement the existing technique in creating investment portfolio. In particular, this method and system is based on the level of potential for conflict of interest (COI) associated with the investment process and its components. The COI has its origin in the interaction among market participants, business arrangements and practices, operational environment, market structure and other relevant factors. The advantage of the present invention is that the COI risk becomes a primary factor in the process of creating portfolio. The COI method raises the awareness of the conflict of interest that exists within the investment process. It also provides a systematical tool to analyze COI risk in the market structure.

Overview of the COI Method for Asset Allocation:

Part I. Preliminary:

Step 001: Derivation of the Conflict of Interest Score (COIS) for relevant factors associated with the market participants and infrastructure.
Step 002: The results of Step 001 are compiled into COIS Assignment Matrix (COISAM).
Step 003: Defining Input Check List Database which will store the Overall COIS and MRD for each manager.
Step 004: Creating Input Check List (ICL) which comprises COIS Assignment Matrix and Manager Related Data (MRD).

Part II. To populate the ICL Database, the following steps 100 thru 300 are repeated for each investment manager who will implement the asset allocation.

Step 100: Base on Input Check List, collect inputs and select appropriate COI Score (COIS) for each input.
Step 200: The summation of the selected COIS from Step 100 generates an Overall COIS associated with the entire investment process and the portfolio manager.
Step 300: Enter Overall COIS and MRD for each portfolio manager into the ICL database.

### Part III. Applications

The COI method provides a new framework for analyzing investment related issues. One of the applications is to create an investment portfolio by way of reducing or diversification of COI risk.

Part I. Preliminary:

Step 001: Derivation of the COIS is accomplished by performing qualitative analysis of relevant factors associate with the investment process and its components in term of potential level of conflict of interest (COI). The investment process and its components include, but are not limited to the following: client, research report, manager, trader, Broker-Dealer (BD), dark pool and exchanges. The relevant factors include, but not limited to the following: the background of the client, interaction among market participants, business arrangement and practice, operational environment, market structure, rule and regulation, and all other related factors.

The qualitative assessment includes the evaluation of all relevant factors associated with the components. The assessment is based on the nature and characteristics of the factor, its interaction with other relevant factors, in conjunction with the public and private information and knowledge regarding to the compliance issues, illegal practices and current litigations in the court system.

The result of analysis determines the level of COI for the relevant factor. The three levels of potential of conflict of interest are low, medium and high; and it is assigned a numerical value of 1, 2 and 3, respectively. The numerical value is the Conflict of Interest Score (COIS) for the relevant factor under analysis. The COIS is cumulative. The number of levels for COI in this method can be expanded depending on the complexity of the method required.

The COI method is intended for the benefit and protection of the general investor. The spirit of fiduciary responsibility and ethical business practice should be exercised when working with the COI method. The COI Method is not intended to be used as a marketing tool.

Derivation of COIS for the Client of the Investment Manager

Knowledge and experience of the client are the two factors used in the determination of COIS for a client. A sufficient amount of knowledge and experience in the area of investment processes and illegal industry practices will reduce predatory practices against the client which leads to lower potential for conflict of interest. The COIS for a client is determined based on the evaluation of the following criteria.
a. Client does not have NASD S/24 qualification or equivalent knowledge, the potential level of COI is high; COIS: 3.
b. Client has S/24 qualification or equivalent knowledge or understands the investment processes and the industry illegal and questionable practices. The potential COI is medium; COIS: 2.
c. Client has implemented a monitoring program to identify illegal practices and compliance problems associate with financial service providers. The potential COI is low; COIS: 1.

Derivation of COIS for the Research

Depending on the origin of the research report, and number of users sharing the report, the potential level of COI is determined as follows:
a. Independent in-house research reports, dedicated to one user, represents low potential for COI; COIS: 1.
b. Purchased research reports from independent research firms or when there are multiple users of the research report; COIS: 2.
c. Research report is provided by Broker/Dealer who is a potential competitor with inherent conflict of interest, motivation behinds the report is uncertain, the potential COI is high; COIS: 3.
d. If multiple research sources are used, select the one with the highest COIS for this section.

Derivation of COIS for the Investment Manager

The factors used for determining COIS for Investment manager are: manager's organization structure, business arrangement and practice. Additional information for manager is collected according to the Manager Related Data (MRD) in ICL. The COIS for an investment manager is cumulative.
a. For an investment manager who is independent from any other organization, the potential for COI is low; COIS: 1.
b. For manager who is part of Broker-Dealer (BD) organization, works with multiple clients, shares resources such as research and trading staff, the potential for COI is medium; COIS: 2.
c. For manager who has soft dollar arrangement with Broker/dealer, the potential for COI is high; COIS: 3.
d. For manager uses fundamental analysis only and does not perform timing analysis; COIS: 3.

Derivation of COIS for the Trader

The years of trading experience of the trader and the availability of trading tools are the factors in evaluation of COIS.
a. For simplicity, if majority of the traders in the trading department have more than 8 years of experience, COIS: 1. If majority of the traders have less than or equal to 8 years but greater than 3 years of experience, COIS: 2. If majority of the traders have less than or equal to 3 years of experience, COIS: 3.
b. For trading department without transaction analysis program in place, ability to detect transaction type of problem is weakened, COIS: 3, otherwise, COIS: 1.
c. For a trading department not using an iceberg facility, the ability to hide the order is reduced, COIS: 3, otherwise, COIS: 1.

Derivation of COIS for the Broker/Dealer (BD)

The BD is one of the most significant participants in the investment process. There are many factors in evaluation of COIS for Broker-Dealer, the total COIS for BD is the accumulation of all the COIS associated with the applicable factors.
a. Order execution:
   If order is executed against B/D own inventory, this represents a direct competition between the BD and the client; COIS: 2.
   If BD performs internal matching of order, this may not be a best execution; COIS: 2.
   If both methods are used; COIS: 2.
b. BD Owns investment fund, a competitor; COIS: 1.
c. BD Owns Asset Management firm, a competitor; COIS: 1.
d. For BD has proprietary trading department, this is a direct competitor to the client's interest, with potential for information leakage; COIS: 3.
e. For BD has the Specialist unit on the exchange, a direct competitor to the client with the power of setting opening price, short sell and holding demand/supply information; COIS: 3.
f. For a BD that engages in IPOs, the COIS will be evaluated base on past performance of IPO over the last three year period. For simplicity, at the time of evaluation, if >75% of IPO remains above offering price, COIS: 1; if >50% but <=75% of the IPO remains above offering price, COIS: 2; if <=50% of the IPO remains above offering price, COIS: 3.

Infrastructure Related Issues:

Derivation of COIS for the Dark Pool

The COIS will vary depending on the destination of order execution. There are many factors impacting the potential level of COI for a dark pool, including the user profile of the pool, liquidity, information leakage, pricing and rebate structure and BD algorithm access. For simplicity, assume the liquidity requirement is meet, then the COIS evaluation is based on user profile and potential for information leakage; if multiple dark pools are used, select the one with the highest COIS.
a. There are two types of independent dark pools:
   Buy side participants only, consisting mainly of institution investors, represents a low potential for COI; COIS: 1.
   Buy and sell side participants, sell side mainly consists investment banker and BD, in competition with the buy side participants; COIS: 2.
b. Consortium-Owned Dark Pools; COIS: 2.
c. Broker-Dealer-Owned Dark Pools: COIS: 2.
d. Exchange-Owned Dark Pools; COIS: 2.

Derivation of COIS for the Exchanges

If the order is executed on the exchanges:
a. Low touch, fully automated system; COIS: 1.
b. High touch, specialist involved system; COIS: 3.
c. If both systems are used; COIS: 3.

The components of the investment process and relevant factors will change over time due to both internal and external forces. Recent restructuring of regulatory agencies will also impact the COI level over the long term, the COIS will need to be adjusted to reflect the new reality and conditions. For a more in depth analysis of each of the components, additional factors could be introduced. Since the COIS is cumulative, additional factors will increase the Overall COIS for the investment process. A Component Multiplier could be used to adjust the level of conflict of interest at component level.

Due to the implementation of National Market System (NMS), some of the COIS will need to be modified depending on the degree of success of NMS implementation. The regulatory agencies and court system have significant impact on the COI method on a macro level, stringent rule and regulation with aggressive enforcement will result in a lower level of COIS in general.

Step 002: The COIS are compiled into the COIS Assignment Matrix.

The Conflict of Interest Score Assignment Matrix (COISAM) includes two parts; column 1 represents the relevant factors associate with the components of the investment process. The second part, column 2, is the COIS corresponding to the relevant factor in column 1.

COIS Assignment Matrix:

| Column 1 | |
|---|---|
| Component of Investment Process | Column 2 |
| And Relevant Factors | COIS |
| Client | |
| a. Client does not have NASD S/24 qualification or equivalent knowledge. | 3 |
| b. Client has NASD S/24 qualification or equivalent knowledge or understands | 2 |
| the investment processes and industry illegal and questionable practices. | |
| c. Client has implemented a monitoring program to identify illegal practices and | 1 |
| compliance problems associated with the financial service providers. | |
| Research | |
| a. Independent in-house research reports, dedicated to one user | 1 |
| b. Purchase research report from independent research firm or the research report | 2 |
| is used by multiple users | |
| c. Research report is provided by Broker/Dealer | 3 |
| Investment Manager | |
| a. For investment manager who is independent from any other organization | 1 |
| b. For manager who is part of Broker-Dealer (BD) organization | 2 |
| c. For manager who has a soft dollar arrangement with Broker/dealer | 3 |
| d. For manager uses fundamental analysis only and does not perform timing | 3 |
| analysis | |
| Trader | |
| If majority of the traders have more than 8 years of trading experience | 1 |
| If majority of the traders have less than or equal to 8 years but greater than 3 | 2 |
| years of trading experience | |
| If majority of the traders have less than or equal to 3 years of trading experience | 3 |
| For trading department: | 3 |
| a. For trading department without transaction analysis program in place | |
| otherwise, COIS is: | 1 |
| b. For a trading department not using an iceberg facility | 3 |
| otherwise, COIS is: | 1 |
| Broker/Dealer (BD) | |
| a. Order execution | |
| If order is executed against B/D own inventory | 2 |
| If BD performs internal matching of order | 2 |
| If both methods are used | 2 |
| b. BD Owns Investment Fund | 1 |
| c. BD Owns Asset Management | 1 |
| d. For BD has Proprietary trading department | 3 |
| e. For BD has the Specialist unit on the exchange | 3 |
| f. For a BD engages in IPOs, the COIS will be determined base on the performance | |
| over the last three years at the time of evaluation. | |
| if >75% of IPO remains above offering price | 1 |
| if >50% but <=75% of IPO remains above offering price | 2 |
| if <=50% of the IPO remains above offering price | 3 |

### A. Dark Pool

If multiple dark pools are used, select the one with the highest COIS when computing Overall COIS.

| a. Independent Dark Pools, two types: | |
|---|---|
| Buy side participants only | 1 |
| Buy and sell side participants | 2 |
| b. Consortium-Owned Dark Pools | 2 |
| c. Broker-Dealer-Owned Dark Pools | 2 |
| d. Exchange-Owned Dark Pools | 2 |

### B. Exchanges

If the order is executed on the exchanges:

| | |
|---|---|
| a. Low touch, fully automated system | 1 |
| b. High touch, specialist involved system; | 3 |
| c. If both systems are used | 3 |

The COIS assignment matrix will need to be adjusted over time due to the evolution of the market structure, new ways of doing business, new exchange rules and regulations and increasing client experience and knowledge and other relevant factors.

Step 003, Define ICL Database specification:

Each investment manager will have a record in the database. Each record is collected according to the Input Check List [0041]. The fields of the database are: Overall COIS, investment-objective, investment manager (IM) name, IM years of experience, assets under management (AUM), fund name, fund type, yield, portfolio turn-over rate, 1, 3, 5 and 10 years return data, volatility and market index consistent with the fund type.

Step 004: Input Check List includes COIS assignment matrix and Manager Related Data (MRD):

### Part A: COIS Assignment Matrix

Part B: MRD, it includes the investment-objective, investment manager (IM) name, IM years of experience, asset under management (AUM), fund name, fund type, yield, portfolio turn-over rate, 1, 3, 5 and 10 years return data, volatility and market index consistent with the fund type.

Part II. To populate the ICL database:

To populate the database, Steps 100 to 300 are repeated for each investment manager.

Step 100: Using the Input Check List, collecting Inputs by identifying appropriate situation listed in column 1 and circle the correspondent COIS in column 2.

Input Check List

### Part A: COIS Assignment Matrix

| | COIS |
|---|---|
| Client | |
| a. Client does not have NASD S/24 qualification or equivalent knowledge. | 3 |
| b. Client has NASD S/24 qualification or equivalent knowledge or understands | 2 |
| the investment processes and industry illegal and questionable practices. | |
| c. Client has implemented a monitoring program to identify illegal practices and | 1 |
| compliance problems associated with the financial service providers. | |
| Research | |
| a. Independent in-house research reports, dedicated to one user | 1 |
| b. Purchase research report from independent research firm or the research report | 2 |
| is used by multiple users | |
| c. Research report is provided by Broker/Dealer | 3 |
| d. If multiple research sources are used, select the one with the highest COIS for | |
| this section. | |
| Investment Manager | |
| a. For Investment manager who is independent from any other organization | 1 |
| b. For manager who is part of Broker-Dealer (BD) organization | 2 |
| c. For manager who has soft dollar arrangement with Broker/dealer | 3 |
| d. For manager uses fundamental analysis only and does not perform timing | 3 |
| analysis | |
| Trader | |
| If majority of the traders have more than 8 years of experience | 1 |
| If majority of the traders have less than or equal to 8 years but greater than 3 | 2 |
| years of experience | |
| If majority of the traders have less than or equal to 3 years of experience | 3 |
| Trading Department | 3 |
| a. For trading department without a transaction analysis program in place | |
| otherwise, COIS is: | 1 |
| b. For a trading department not using an iceberg facility | 3 |
| otherwise, COIS is: | 1 |
| Broker/Dealer (BD) | |
| a. Order execution | |
| If order is executed against B/D own inventory | 2 |
| If BD performs internal matching of order | 2 |
| If both methods are used | 2 |
| b. BD Owns Investment Fund | 1 |
| c. BD Owns Asset Management | 1 |
| d. For BD has Proprietary trading department | 3 |
| e. For BD has the Specialist unit on the exchange | 3 |
| f. For a BD engaging in IPOs, the COIS will be selected base on the last three | |
| years of performance at the time of evaluation. | |
| if >75% of IPO remains above offering price | 1 |
| if >50% but <=75% of IPO remains above offering price | 2 |
| if <=50% of the IPO remains above offering price | 3 |

### A. Dark Pool

If multiple dark pools are used, select the one with the highest COIS when computing

Overall COIS.

| a. Independent Dark Pools, two types | |
|---|---|
| Buy side participants only | 1 |
| Buy and sell side participants | 2 |
| b. Consortium-Owned Dark Pools | 2 |
| c. Broker-Dealer-Owned Dark Pools | 2 |
| d. Exchange-Owned Dark Pools | 2 |

### B. Exchanges

If the order is executed on the exchanges:

| | |
|---|---|
| a. Low touch, fully automated system | 1 |
| b. High touch, specialist involved system | 3 |
| c. If both systems are used | 3 |

Part B: Manager Related Data (MRD), it includes the investment-objective, investment manager (IM) name, IM years of experience, assets under management (AUM), fund name, fund type, yield, portfolio turn-over rate, 1, 3, 5 and 10 years return data, volatility and market index consistent with the fund type.

### (End of Input Check List)

Step 200: The summation over all the selected COIS (circled) from Step 100 generates an Overall COIS for the investment process implemented by the investment manager under evaluation.

Step 300: Enter Overall COIS and MRD into ICL database according to the ICL Database specification.

Part III. Applications

The COI method provides a unique framework for analysis of risk involving conflict of interest in the fields of investment. It can be incorporated into existing product or service or starting a new fields of research and applications.

The Overall COIS values have a range of distribution due to the nature and characteristics of market participants and infrastructure. On the low end of the range, it indicates a low potential for COI. It also implies the manager is more independent. The degree of independence can be expressed as the inverse of the Overall COIS. For a manager at the high end of the Overall COIS distribution, there is higher potential for conflict of interest due to the interactions among market participant and infrastructure. It could also imply monopoly or oligopoly situations.

Application A: To complement the existing diversification method; the risk of conflict of interest is considered during the implementation phase. After a portfolio is decided, The Overall COIS could be use as a factor for executing order thru a path with minimum or maximum or combination of different level of COIS.

Application B, a new approach in selecting an investment manager:

Due to the increasing number of managers in the field, the initial selection of a manager becomes an exercise of evaluation of statistical data. On the assumption that Minimum Overall COIS reflects the performance of the manager due to the minimum influence of COI, one alternative way to create the portfolio is by placing Overall COIS and performance as primary factors in selecting a manager. In other words, instead of looking at the manager first, we focus on the minimum level of Overall COIS, and then determine which managers have the top performance in the area of interest. As a by product, this approach will psychologically bring the COI risk into much needed focus.
The high Overall COIS pathway should not be excluded, since high Overall COIS and high performance record implies not only his/her investment capability, but may also indicate abilities and connections in other areas that influence investment result.

Application C: The COI framework could be used to establish an alternative way of creating portfolio; the mathematical distribution of Overall COIS for all the managers creates a unique spectrum that can be used for the purpose.

To illustrate, a sovereignty fund or fund of funds wants to establish an international portfolio to be implemented by multiple managers, a conflict of interest risk factor could be included by specifying Overall COIS as primary criteria in creating a portfolio which leads to the selection of managers who have been implementing similar portfolios. From diversification of COI risk point of view, by specifying minimum Overall COIS, a group of managers can be selected to manage the investment with a high degree of independence while meeting performance and other requirements. On the other hand, by specifying maximum Overall COIS, a group of manager can be selected to manage the investment with a high degree of connection and a vast amount of information which may be beneficial. For the minimum Overall COIS approach, a query to the database in the form of Fund type=International, Overall COIS=minimum, yield>10%, will return the result of the managers who meet the requirements to implement the portfolio, similarly, a query can be constructed for the maximum Overall COIS.
A portfolio is created by specifying Overall COIS and then selecting the best performing manager in the group to generate and implement the portfolio.

Application D: For an investment manager to manage multiple portfolios, the comparison of performance over an extended period of time between minimum Overall COIS and maximum Overall COIS execution path could provide an indication on the performance of downstream service providers.

A Conflict of Interest evaluation system according to an embodiment of the present invention is constructed with input and output devices, memory and processor. Software consists of operation system, spread sheet and database application.

The spread sheet accepts inputs based on the Input Check list, summation over the COIS column provides the Overall COIS for the manager and the process; repeat this step for each manager.

The Overall COIS and the data from the MRD of Input Check List is entered into the database which is stored in the memory. The database is populated by repeating this step for each manager.

The input device is used to accept database query to access the record that satisfy the user requirement base on selection policy.

Various modifications and alterations of this invention will be apparent to those skilled in the art without departing from the scope and spirit of this invention. This invention should not be restricted to that set forth herein for illustrative purposes only.

I claim:

1. A method for selecting investment manager and investment process comprises qualitative assessment of the potential level of Conflict of Interest (COI) for relevant factors relating to the components of the investment process;
the relevant factors including the background of the client, interaction among market participants, business arrangement and practice, operational environment, market structure, rule, regulation and all other related considerations;
the components of the investment process including the client, research, investment manager, trader, broker-dealer, dark pool, exchange and regulatory agency, and all other related entities.

2. The method of claim 1, wherein the qualitative assessment of each relevant factor for potential of conflict of interest is based on the nature and characteristics of the factor, its interaction with other relevant factors, in conjunction with information and knowledge available on the compliance issues, illegal practices and litigations in the court system.

3. The method of claim 2, wherein each of all the relevant factors is assigned one of the three potential levels of conflict of interest: low, medium or high, representing by a numerical value of 1, 2 or 3, respectively; the numerical values representing the Conflict of Interest Score (COIS).

4. The method of claim 3, wherein the COIS for each of the relevant factors is compiled into a COIS Assignment Matrix (COISAM) consisting of two parts:
Part 1, column 1, grouping of relevant factors by the components of the investment process;
Part 2, column 2, consisting of the COIS corresponding to the relevant factor in the column 1.

5. The method of claim 4, further comprising Input Check List (ICL) which has two parts;
Part A: COISAM; and
Part B: Manager Related Data (MRD), consisting of the investment-objective, investment manager (IM) name, IM years of experience, asset under management (AUM), fund name, fund type, yield, portfolio turn-over rate, 1, 3, 5 and 10 years return data, volatility and market index consistent with the fund type.

6. The method of claim 5, further comprising the steps of: collecting of the inputs; matching the inputs with the Column 1 of the COIS Assignment Matrix of the ICL and selecting the corresponding COIS from the column 2; these steps are repeated for each manager.

7. The method of claim 6, further comprising the summation of the selected COIS to generate an Overall COIS for the manager and related investment process; this summation operation is repeated for each manager wider evaluation.

8. The method of claim 7, further comprising the ICL Database consisting of the Overall COIS and the manager related data (MRD); the ICL Database is populated by entering Overall COIS and MRD for each of the managers and related process under evaluation.

9. The method of claim 8, further comprising the investment manager and related process selection policy in term of Overall COIS, manager performance and other selection criteria listed in MRD; the policy is restated into database query language to obtain desire result.

10. The method of claim 9, further comprising the following interpretation modules regarding to the Overall COIS:
A. Overall COIS indicating the degree of independent of the manager and the complexity of the investment process, where degree of independent is expressed as the inverse of Overall COIS;
B. Maximum Overall COIS value indicating the need to implement a monitoring program to assure investment process integrity which will have direct impact on the performance of the investment;
C. Minimum Overall COIS indicating performance data is a reflection of the manager's investment ability due to minimum influence by the conflict of interest.

11. The method of claim 9 further comprising the use of Overall COIS as decision factor in implementing a portfolio which leads to the selection of mangers who can support the level of COI risk while maintain other requirements.

12. The method of claim 9 further comprising the diversification of portfolio base on the mathematical distribution of the Overall COIS.

13. The method of claim 9 further comprise the use of Overall COIS as a basis for monitoring service provider's performance.

14. A Conflict of Interest (COI) system for selecting investment manager and investment process comprises hardware: input and output devices, memory, processor; and software: spread sheet and database applications and operating system.

15. The method of claim 14, wherein the spread sheet is used to compute the Overall COIS according to the Input Check List for each manager.

16. The method of claim 15, wherein the ICL database is populated by the Overall COIS and the MRD from each of the managers.

17. The method of claim 16, wherein the input device is used to enter query command specifying the selection policy in database language to access record.

18. The method of claim 17, wherein the processor interpreting the query language, searching the database and placing the result on output device that displays the manager's names and related information that satisfy the selection requirements.
